(19) United States
(12) Patent Application Publication
(10) Pub. No.: US 2025/0095475 A1
(43) Pub. Date: Mar. 20, 2025

(54) SMART ERUV POLE TO IMPROVE MONITORING AND CONTROL OF COMPLIANCE WITH HALACHIC REQUIREMENTS

(71) Applicant: Binyamin Baruch ROTSTEIN, Jerusalem (IL)

(72) Inventor: Binyamin Baruch ROTSTEIN, Jerusalem (IL)

(21) Appl. No.: 18/884,302

(22) Filed: Sep. 13, 2024

(30) Foreign Application Priority Data
Sep. 20, 2023 (IL) 306105

(51) Int. Cl. G08B 21/18; G01B 21/22; G01L 5/04

(52) U.S. Cl. CPC G08B 21/182; G01B 21/22; G01L 5/047

(57) ABSTRACT

In aspects of the present invention there is provided an eruv pole configured for maintaining and controlling eruv in accordance with the requirements of Halacha. This eruv pole includes at least one wire; at least one biasing means storing energy during stretching of the wire; at least one switch being actuated during a release of the stored energy; at least one transmitter communicably coupled to the switch, said transmitter sending at least one signal according to the switch status, said signal indicative of the wire tension; and at least one polyspast with at least one moving pulley translated by the biasing means. The moving pulley and the biasing means cooperate together as a tensioner for maintaining tension in the wire as long as the wire remains intact.

### CROSS-REFERENCES TO RELATED APPLICATIONS

This application claims priority of the Israeli patent application No. 306105, filed on Sep. 20, 2023, entitled SMART ERUV POLE TO IMPROVE MONITORING AND CONTROL OF COMPLIANCE WITH HALACHIC REQUIREMENTS by Binyamin Rotstein.

### TECHNICAL FIELD

The present invention is related to meeting halachic eruv requirements, more specifically, the present invention is related to the installation of the eruv, and to the prevention of malfunctions, monitoring, and control of the state of the eruv.

### BACKGROUND

On Shabbat, there is a prohibition to remove objects from the property of the individual (such as a residence) to the property of the public and vice versa. This prohibition is one of the thirty-nine crafts that are forbidden on Shabbat according to the Torah, and it is called in short: hotzaah mereshut lereshut (Hebrew: [symbol] [symbol] [symbol] ) or transferring objects between domains. In order to allow hotzaah on Shabbat, there is a halachic solution to create a ‘mixing’ of domains called eruv (Hebrew: [symbol] ). The eruv defines multiple domains as one private domain thus allowing hotzaah. The installation of an eruv enables the routine of Shabbat life when it comes to taking objects out of the house such as a prayer arrangement or a pram. The goal of the eruv is to halachically enclose the locale in order to deem it within its boundaries, a private domain. The most common method of creating the mixture today is, by ‘Tzurot hapetach’, (Hebrew: [symbol] ), or openings by installing dedicated poles over which a thin, stretched thread passes. From a halachic point of view, the opening is considered a kosher partition by means of which the enclosed area becomes a private domain, provided that the thread should pass precisely over the posts. It is required also that the thread be taut and not loose so that it does not come out of the perimeter of the posts due to fluctuations. In addition, the posts should be straight so that the thread would not be outside the perimeter of the lower part of the column, as well as to maintain the shape of the opening according to halachic requirements. The ‘Tzurot hapetach’ method encompasses several vital prerequisites for ensuring kosher compliance according to Halacha. This comprehensive approach to maintenance and operation is collectively referred to as ‘eruv’. The inventor's intimate familiarity with ‘eruv’ stems from years of hands-on experience overseeing ‘eruv’ matters in various communities across Israel, including the city of Jerusalem.

To ensure the integrity of the ‘eruv’ as close as possible to the start of Shabbat, designated inspectors traverse the ‘eruv’ route. Their task is to verify that the eruv thread remains intact and sufficiently tight and that the columns are undamaged, along the entire route. This verification and correction of defects requires significant time and resources. It should be noted that certain sections of the ‘eruv’ route may pass through areas that are not easily accessible. Because of the absence of reliable and rapid reporting, and the uncertainty of whether damages can be addressed before Shabbat, precautionary safety measures are implemented. These measures entail conducting inspections even when no apparent issues are detected. It is of utmost importance that the reports received by the center responsible for a specific eruv area are focused and informative. This should include the precise location and a description of the issue, allowing for the selection of the appropriate repair action. For instance, a team specialized in erecting pillars will be dispatched to the location of a fallen pillar. Similarly, if a wire is torn or loosened, a dedicated team skilled in wire arrangement will be sent. Ensuring continuous reporting on the eruv's condition up until shortly before the start of Shabbat or a holiday is essential. Lastly, akin to any alarm system, minimizing false alarms is crucial to prevent a decrease in vigilance and the unnecessary allocation of resources.

### Common Existing Techniques and Knowledge

When a torn eruv thread is discovered, the process of stretching a new thread is conducted in several steps. Initially, a bundle of new eruv thread is positioned near the first of two columns between which the thread was torn. Using a long telescopic rod, the thread is elevated to the top of the first column. The thread's continuation is then guided up to the second column using the telescopic rod, after which the bundle is moved near the second column. The section of the thread connected to the bundle is drawn downwards, securely fastened to the second column, and tightened. Lastly, the segment of thread between the tie and the bundle is cut. The utilization of the telescopic rod eliminates the need for ladders, which are considered less safe. On occasion, when necessary, a basket crane is employed; however, this is a costly and time-intensive operation that necessitates coordination. A simpler scenario arises when the thread is loose but remains intact. In this case, the thread's end is released from its tie to the column, stretched to the desired tautness, and then retied.

Actually repairing an eruv following a wire break as described above is almost the same as installing a new eruv. To illustrate the matter even more perfectly and to help in understanding the description of the invention below, the following is a description of the installation of a new eruv accompanied by figures. The first stage of erecting Eruv 100 is schematically depicted in FIG. 1A where bundle 122 of new eruv thread 120 appears positioned near first column 110A. The free end of eruv wire 120 is attached to an anchoring point 112 on column 110A, which can be, for example, a lug, eyelet, nail, screw, or similar fastener. The next step is depicted in FIG. 1B where telescopic rod 124 is used to raise wire 120 to guide 114A installed at the top of column 110A. Next, as shown in FIG. 1C, using telescopic rod 112, thread 120 continuation is guided up to guide 114B installed on top of second column 110B. After that, bundle 122 is moved near column 114B. The final stage is depicted FIG. 1D. Thread 120 is cut, disconnected from bundle 122, drawn downwards, and tied to anchoring point 112 attached to column 110B. A sequence of a number of eruv columns is depicted in FIG. 1E with wires 120, installed in the method described above.

To address the challenges of monitoring and controlling the eruv and its supreme importance to numerous Jewish communities, efforts have been made to streamline this field. For example, patent IL121617 from 1997 describes a system for automatic testing of eruv in which it is proposed to use an active eruv wire (optical fiber, electrical wire, water line). Apart from the high costs of using this wire, this method involves expensive maintenance due to the need for complex and expensive connections. The proposed system requires considerable maintenance time. The wires cannot be stretched as required practically and halachically. Another disadvantage is the possibility of failures to indicate that the eruv is halachically invalid, for example when the thread fell to the side of the pillar but remained intact, or when the pillar fell together with the thread. Moreover, a situation of multiple wire disconnections will not be indicated, but in the best case, only the first disconnection that occurred. An important reason that there has been a reluctance to adopt this method is due to the use of a specialized active thread instead of a regular eruv thread. Ultimately this method is not halachically approved. There is also a company called “Haeruv hadigitaly” (Hebrew: [symbol] [symbol] ) that has been trying for several years to offer a system that includes a cellular SIM installed for each two eruv wires. Some hypothesize that this system includes a weight for stretching the eruv thread. Yet it seems that the system has some disadvantages:
1. The system is expensive to operate since it requires many cellular transmission points
2. The system cannot be implemented in places without cellular reception
3. In the demonstration of the system in the city of Ashdod, it seemed that this system includes digital means whose reliability is insufficient. It seems that the system sends false alerts on a torn eruv thread even though the thread is intact and kosher, and vice versa on an intact thread even though the thread was torn even after calibration attempts, as reported by eruv inspectors in Ashdod. An example of a possible false alarm in this system is when a bird settles on the eruv thread whose weight causes the eruv thread to tighten. When the bird leaves the thread a drop in the thread's tension may occur that may be reported as if the thread is torn. False alerts may also occur due to changes in the condition of the wire as a result of weather changes, humidity, etc. Thus, it seems that this method cannot be employed to improve the oversight on eruv.
4. Another disadvantage of this system is that it does not include an effective means of keeping the tension in the wire and preventing slack.
5. It seemed in the demo in Ashdod, that it is necessary to climb the pole to a height of about 4 meters in order to repairments, stretch and tie the eruv thread. A loose or torn thread cannot be repaired from the ground as is possible in the working method used today.

Due to the shortcomings and ineffectiveness of this system, apart from a few test poles on the seashore in Ashdod that were installed by the inventor himself for testing, that seemed to fail, this system did not come into use.

The terms “post”, “pillar”, “column”, and “pole” may be used interchangeably hereinafter.

The terms “thread”, “yarn”, and “wire” may be used interchangeably hereinafter.

The terms “complete” and “intact” may be used interchangeably hereinafter.

The term “translated” used in herein may refer to linear or curvilinear movement.

The terms “pole tilt” and “pole inclination” may be used interchangeably hereinafter.

The terms “pulley” and “wheel” may be used interchangeably hereinafter.

The terms “erection” and “installation” may be used interchangeably hereinafter.

### SUMMARY OF EMBODIMENTS OF THE INVENTION

The present invention aims to address the challenges associated with monitoring and controlling eruv. Its primary objectives include:
1. Enabling reliable and swift reporting of eruv issues.
2. Keeping the eruv thread taut.
3. Safe and easy construction and operation of the eruv, among other things, by making it possible to perform most of the required operations from the ground.
4. Reducing operational costs and time involved in eruv construction, maintenance, and monitoring.

In aspects of the present invention there is provided an eruv pole configured for maintaining and controlling eruv in accordance with the requirements of Halacha. This eruv pole includes at least one wire; at least one biasing means storing energy during stretching of the wire; at least one switch being actuated during a release of the stored energy; at least one transmitter communicably coupled to the switch, said transmitter sending at least one signal according to the switch status, said signal indicative of the wire tension; and at least one polyspast with at least one moving pulley translated by the biasing means. The moving pulley and the biasing means cooperate together as a tensioner for maintaining tension in the wire as long as the wire remains intact. The polyspast may ease the stretching of the wire during the construction or repair of the eruv, by reducing the force required to stretch the wire and reducing the required stretch length. The use of polyspast allows for reducing the dimensions of the system, especially the parts related to stretching the wire. Reducing dimensions is also desirable from an aesthetic point of view, for example in locations where an eruv is installed in residential and recreation areas. Using pulleys reduces the friction of the thread on other parts of the eruv and is supposed to reduce the sticking of the thread. In some embodiments of the invention, instead of pulleys rollers or rolls or other shapes on which the wire is wound can be used. Bearings can also replace the pulleys. In some examples, the biasing means changes its shape due to the release of energy. This change in shape may cause the actuation of the switch. For example, changing the length of a spring can cause the spring to exert a force on a switch mounted at a fixed point relative to the spring. Besides a spring, the biasing means may be for example an elastic band, a torsion bar, a pneumatic cylinder, a hydraulic cylinder, a magnet, and combinations thereof. According to different embodiments of the invention switches can be of different types such as mechanical, inductive, capacitive, ultrasonic, magnetic, optical, and photoelectric, Hall Effect, proximity, Mechanical Roller Plunger, and new kinds of switches that may be developed in future. Typically, switches are characterized by durability and reliability and do not require periodic calibration. In some examples embodying the invention the actuation of the switch during a release of the stored energy occurs when the energy release is greater than a predetermined threshold. This arrangement may help to differentiate between non-serious slack in the wire that does not require immediate intervention or any intervention at all, and severe slack in the wire resulting from, for example, a tear that requires immediate repair. In some embodiments the moving pulley is connected to the biasing means such that the change in shape of the biasing means causes the translation of the moving pulley. The advantage of a system according to some embodiments of the invention is that it allows the replacement of the eruv wire without having to dismantle the tensioning and alarm mechanism which includes, among other things, a switch and a transmitter. For even further comprehensive monitoring and controlling of the eruv, in some embodiments of the above aspects the eruv pole includes at least one tilt sensor that sends at least one signal when the pole tilts more than a predetermined threshold. Eruv poles should be straight. Excessive tilt requires repair. The degree to which the eruv column is inclined dictates the response required by the team overseeing the eruv. A minimal degree of tilt of an eruv column is not considered a condition that requires urgent intervention or even intervention at all. On the other hand, a tilt above a certain threshold constitutes a fault in the eruv that requires immediate correction.

According to some aspects of the present invention there is provided a system for monitoring and controlling eruv, and locating and specifying eruv malfunctions. This system includes at least one wire; at least two eruv poles connected with said wire; at least one biasing means storing energy during stretching of said wire; at least one switch being actuated during a release of the stored energy; at least one polyspast with at least one moving pulley translated by the biasing means. The moving pulley and the biasing means cooperate together as a tensioner for maintaining tension in the wire as long as the wire remains intact. This system also includes at least one transmitter communicably coupled to said switch. The transmitter sends at least one first signal according to the switch status and the location of the switch. Information about the location of the switch helps in locating the loose thread along the eruv. The type of signal that can contain information about both the location and switch status could be a data signal or a telemetry signal. Data signals can carry various types of information, including location data from GPS or other positioning systems. Telemetry signals are commonly used to transmit data from remote locations. As discussed previously, in some instances, the actuation of the switch occurs when the stored energy release exceeds a predetermined threshold. Additionally, the system may include at least one tilt sensor that sends a second signal concerning the tilt and location of the pole, for the reasons already mentioned in this regard. A system embodying the invention may include at least one display module configured to receive and process said first signal, and to display information corresponding to the switch status and the switch location. The display module may be configured to receive and process said second signal, and to display information corresponding to tilt, and poles' location. Display module can enable displays such as a map in which the locations from which the signals were transmitted are shown. The display module could be designed to process the location information from the transmitted signals and overlay it on a map, providing a visual representation of the signal sources' locations. This can enhance the user's understanding of the eruv status and the locations related to the signals being received. A display module can allow the production of messages displayed on a phone or other device. These messages can contain information derived from the received signals, such as details about the switch status, switch location, tilt information, or any other relevant data. The display module could process the signals and generate user-friendly messages or notifications that provide information about the monitored conditions, allowing users to understand and respond to the eruv's status easily. The components of a display module could include:
1. Processor: This is the central processing unit responsible for receiving, processing, and analyzing the incoming signals or data.
2. Memory: The memory stores the necessary software, algorithms, and data needed for processing and displaying information.
3. User Interface: This includes the display screen (e.g., smartphone screen, computer monitor) where information is shown to the user, and input methods such as touchscreens or buttons for user interaction.
4. Communication Interface: This component enables communication between the display module and other system components, such as the transmitters or sensors sending signals.
5. Software/Application: The software or application running on the display module interprets the incoming signals, generates messages or notifications, and presents them in a user-friendly format on the display.
6. Mapping/GPS Integration: The display module might integrate with mapping or GPS services to show locations on a map.
7. Notification System: The display module can be designed to generate and send notifications to users, alerting them about specific events or conditions detected by the system.
8. User Preferences: User settings and preferences can be stored and managed within the display module, allowing users to customize how information is presented to them.
9. Power Management: Depending on the device, power management components may be included to optimize energy usage and battery life.
10. Networking components: allowing the display module to interact with remote systems or databases.

A method according to some aspects of the present invention for monitoring and controlling eruv compliance with Halacha requirements includes tying a wire to first eruv pole; elevating the wire to the top of said first pole; guiding the wire continuation up to the top of a second eruv pole; threading the wire within the groove of at least one pulley in at least one polyspast; threading the wire within the groove of at least one pulley of at least one tensioner; stretching the wire against said tensioner resistance; tying the wire to said second eruv pole; receiving at least one first signal from at least one switch being actuated when the wire tension decrease below a predefined threshold; and receiving the switch location. The method may include receiving at least one second signal from at least one tilt sensor when at least one of said poles tilts more than a predetermined threshold; and receiving said pole location. In some examples the method includes processing said first and second signals to display information corresponding to said switch, said switch location, said tilt, and said location of at least one of said poles. In some embodiments of the invention the method of includes processing said second signals to display information corresponding to said tilt, and said location of at least one of said poles.

### BRIEF DESCRIPTION OF THE DRAWINGS

A complete understanding of the present embodiments and the advantages and features thereof will be more readily understood by reference to the following detailed description when considered in conjunction with the accompanying drawings. Embodiments of the present disclosure are illustrated as examples and are not limited by the figures of the accompanying drawings, in which like references may indicate similar elements and in which:

FIG. 1A illustrates schematically the first stage of erecting eruv according to some prior art techniques.

FIG. 1B illustrates schematically the second stage of erecting eruv according to some prior art techniques.

FIG. 1C illustrates schematically the third stage of erecting eruv according to some prior art techniques.

FIG. 1D illustrates schematically the final stage of erecting eruv according to some prior art techniques.

FIG. 1E illustrates schematically a sequence of number of eruv columns with eruv wires installed according to some prior art techniques.

FIG. 2A illustrates schematically a perspective of a smart eruv pole assembly with eruv wire properly taut according to some embodiments of the invention.

FIG. 2B illustrates schematically a perspective of a smart eruv pole assembly with eruv wire properly taut according to some embodiments of the invention.

FIG. 3A illustrates schematically a perspective of the surrounding of a movable pulley according to some embodiments of the invention.

FIG. 3B illustrates schematically a perspective of the surrounding of a movable pulley according to some embodiments of the invention.

FIG. 4A illustrates schematically a perspective of the surrounding of a fixed pulley according to some embodiments of the invention.

FIG. 4B illustrates schematically a perspective of the surrounding of a fixed pulley according to some embodiments of the invention.

FIG. 4C illustrates schematically a perspective of the surrounding of a fixed pulley according to some embodiments of the invention.

FIG. 5A illustrates schematically a perspective of the surrounding of an alert module according to some embodiments of the invention.

FIG. 5B illustrates schematically a perspective of the surrounding of an alert module according to some embodiments of the invention.

FIG. 5C illustrates schematically a perspective of the surrounding of an alert module according to some embodiments of the invention.

FIG. 5D illustrates schematically a perspective of the surrounding of an alert module according to some embodiments of the invention.

FIG. 6A illustrates schematically a perspective of a smart eruv pole assembly according to some embodiments of the invention.

FIG. 6B illustrates schematically a perspective of a smart eruv pole assembly according to some embodiments of the invention.

FIG. 7A illustrates schematically the first stage of erecting eruv according to some embodiments of the invention.

FIG. 7B illustrates schematically a stage of erecting eruv according to some embodiments of the invention.

FIG. 7C illustrates schematically a stage of erecting eruv according to some embodiments of the invention.

FIG. 7D illustrates schematically a stage of erecting eruv according to some embodiments of the invention.

FIG. 7E illustrates schematically a stage of erecting eruv according to some embodiments of the invention.

FIG. 7F illustrates schematically a stage of erecting eruv according to some embodiments of the invention.

FIG. 7G illustrates schematically a stage of erecting eruv according to some embodiments of the invention.

FIG. 7H illustrates schematically a sequence of number of smart eruv poles with eruv wires installed according to some embodiments of the invention.

FIG. 8 illustrates schematically possible substitutes for the pulleys according to some embodiments of the invention.

FIG. 9A illustrates schematically, a network of communication and an eruv wire rupture alert according to some embodiments of the invention.

FIG. 9B illustrates schematically, a network of communication and an absence of a “heartbeat signal” according to some embodiments of the invention.

FIG. 9C illustrates schematically, a network of communication and a tilted pole alert according to some embodiments of the invention.

FIG. 9D illustrates schematically, an online map display of the state of the eruv on a computer screen and a mobile phone screen according to some embodiments of the invention.

FIG. 10A is a flowchart of erecting eruv according to some embodiments of the invention.

FIG. 10B is a flowchart of erecting eruv according to some embodiments of the invention.

FIG. 10C is a flowchart of control of eruv according to some embodiments of the invention.

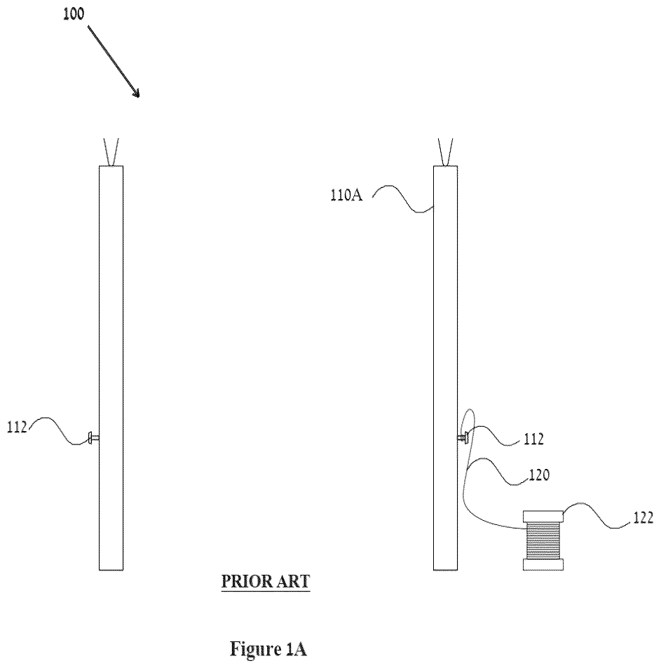

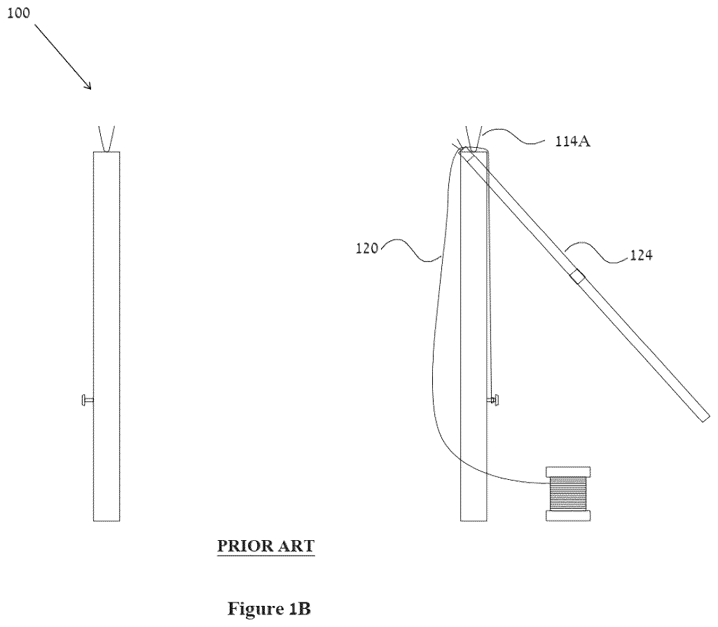

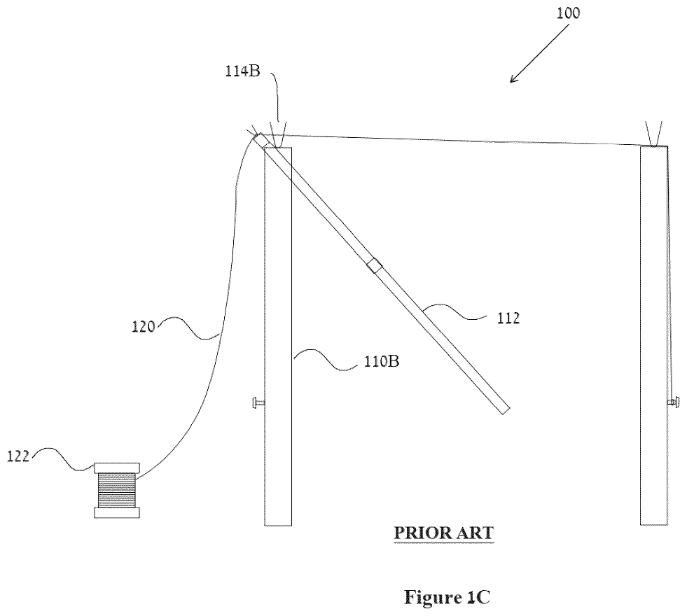

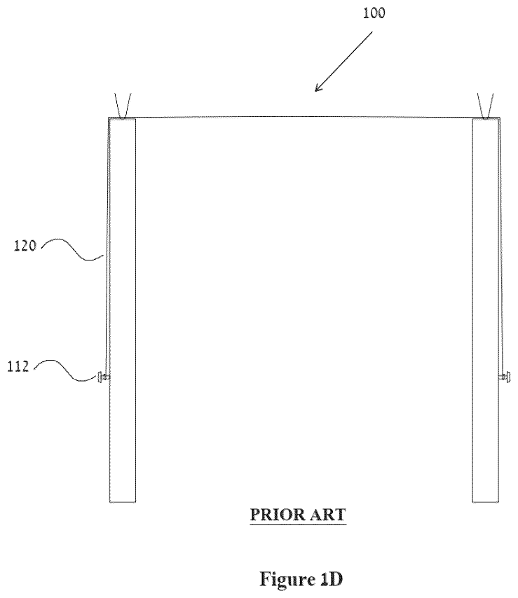

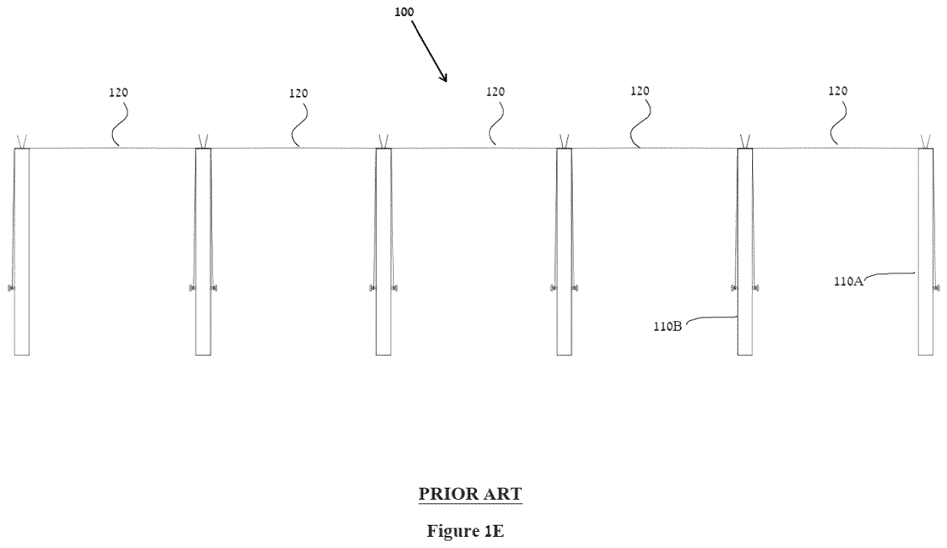

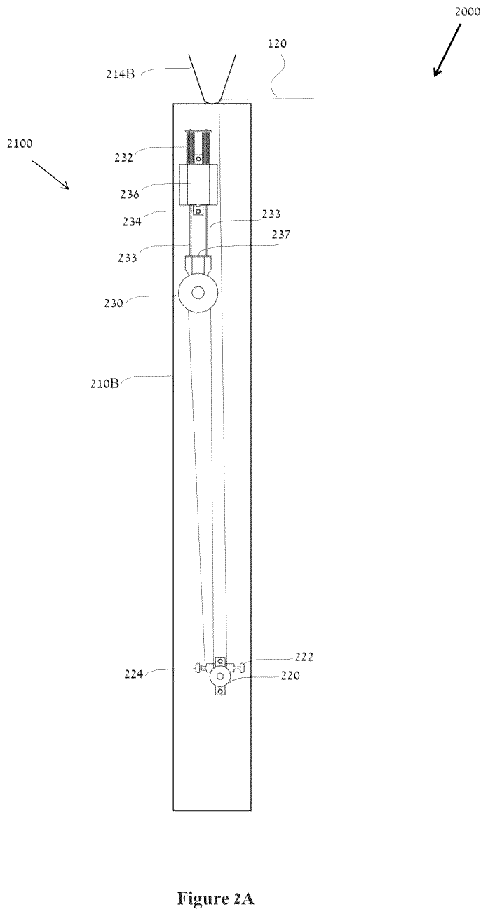

### DETAILED DESCRIPTION OF EMBODIMENTS OF THE INVENTION

The specific details of the single embodiment or variety of embodiments described herein are to the described system and methods of use. Any specific details of the embodiments are used for demonstration purposes only, and no unnecessary limitations or inferences are to be understood thereon. Before describing in detail exemplary embodiments, it is noted that the embodiments reside primarily in combinations of components and procedures related to the system. Accordingly, components have been represented, where appropriate in the drawings, showing only those details that are pertinent to understanding the embodiments of the present disclosure so as not to obscure the disclosure with details that will be readily apparent to those of ordinary skill in the art having the benefit of the description herein.

On Shabbat, there is a prohibition to remove objects from the property of the individual (such as a residence) to the property of the public and vice versa. This prohibition is one of the thirty-nine crafts that are forbidden on Shabbat according to the Torah, and it is called in short: hotzaah mereshut lereshut (Hebrew: [symbol] [symbol] [symbol] ) or transferring objects between domains. In order to allow hotzaah on Shabbat, there is a halachic solution to create a ‘mixing’ of domains called eruv (Hebrew: [symbol] ). The eruv defines multiple domains as one private domain thus allowing hotzaah. The installation of an eruv enables the routine of Shabbat life when it comes to taking objects out of the house such as a prayer arrangement or a pram. The inventor's intimate familiarity with ‘eruv’ stems from years of hands-on experience overseeing ‘eruv’ matters in various communities across Israel, including the city of Jerusalem.

To ensure the integrity of the ‘eruv’ as close as possible to the start of Shabbat, designated inspectors traverse the ‘eruv’ route. Their task is to verify that the eruv thread remains intact and sufficiently tight and that the columns are undamaged, along the entire route. This verification and correction of defects requires significant time and resources. It should be noted that certain sections of the ‘eruv’ route may pass through areas that are not easily accessible. Because of the absence of reliable and rapid reporting, and the uncertainty of whether damages can be addressed before Shabbat, precautionary safety measures are implemented. These measures entail conducting inspections even when no apparent issues are detected. It is of utmost importance that the reports received by the center responsible for a specific eruv area are focused and informative. This should include the precise location and a description of the issue, allowing for the selection of the appropriate repair action. For instance, a team specialized in erecting pillars will be dispatched to the location of a fallen pillar. Similarly, if a wire is torn or loosened, a dedicated team skilled in wire arrangement will be sent. Ensuring continuous reporting on the eruv's condition up until shortly before the start of Shabbat or a holiday is essential. Lastly, akin to any alarm system, minimizing false alarms is crucial to prevent a decrease in vigilance and the unnecessary allocation of resources.

The existing technique is described in the background section, as well as various attempts to improve the monitoring and control of the eruv. The inventor of the present invention has observed that the challenges associated with monitoring and controlling eruv have not been addressed sufficiently. Thus, the present invention aims to improve the existing situation. The present invention primary objectives include:
1. Enabling reliable and swift reporting of eruv issues.
2. Keeping the eruv thread taut.
3. Safe and easy construction and operation of the eruv, among other things, by making it possible to perform most of the required operations from the ground.
4. Reducing operational costs and time involved in eruv construction, maintenance, and monitoring.

A system for monitoring and controlling eruv compliance with Halacha requirements according to some aspects of the present invention includes at least one eruv wire; at least one biasing means storing energy during stretching of said wire; and at least one transmitter actuated by said biasing means, wherein when actuated, said transmitter transmits at least one signal indicating that said wire or part thereof is loose. The biasing means may take various forms, such as a spring, an elastic band, a torsion bar, pneumatic and hydraulic cylinders, magnets, and combinations thereof. The biasing means may be connected to at least one end of said wire. According to some embodiments the biasing means exerts a force that keeps said wire stretched as long as said wire is complete. According to some embodiments the actuation of the transmitter is being resulted by said stored energy being released. In some examples, this actuation occurs when said energy release is greater than a predetermined threshold. In some embodiments said energy release causes the biasing means to change shape. This change in shape may cause said actuation of said transmitter. In some embodiments, at least one actuator is, connected to the biasing means, while the change in shape of the biasing means causes the actuator to actuate the transmitter. The system may include least one polyspast with at least two pulleys optionally connected together by said wire, at least when said wire is complete. At least one of these pulleys is stationary, and at least one is movable. The movable pulley may be connected to the biasing means, such that the change in shape causes the movable pulley to move. According to some embodiments the system includes at least two eruv poles connected by said eruv wire; and at least one tilt sensor connected to at least one of said poles, said sensor sends at least one signal when said pole tilts more than a predetermined threshold.

A method according to some aspects of the present invention for monitoring and controlling eruv compliance with Halacha requirements includes: stretching at least one eruv wire between at least two eruv poles; storing energy in at least one biasing means by said stretching; releasing said energy when loosening of said wire occurs; and transmitting at least one signal when said releasing is in a magnitude above a predefined threshold. Said signal indicative of deviation from Halacha requirements. In some examples the biasing means and the wire cooperate such that the wire is kept stretched by the stored energy as long as the wire is complete. The method may include winding the wire on at least two wheels of polyspast. In some cases the method includes transmitting at least one signal when at least one of the poles tilts more than a predetermined threshold. It should be noted, that the importance given to pole tilt, usually is less than wire break, however up to certain degree. For example, a pole tilt of up to half a degree of sometimes 0.8 degree may be considered a minor issue. A typical diameter of an eruv pole is around 9 centimeter or 3″. A typical height of an eruv pole would be around 5.2 meters above ground. The aim is to keep the position of the wire on top of the pole inside the perimeter of the pole in its lower parts. Thus, at sufficiently large tilt, the wire will exceed the pole perimeter. A tilt between 0.5 or 0.8 degree to 4 degree may be considered more of an issue compared to a tilt below this range. At a greater tilt of more than 4 degrees, there is an obligation for repair. Yet only at a tilt beyond 45 degrees is considered severe. The difference in the importance given to wire break compared to pole tilt is reflected in the difference in the manner in which those two potential issues are handled according to some embodiments mentioned above. While detection of a wire break is monitored using a switch actuated by biasing means, the tilt monitoring relies on a sensor. The present inventor had contemplated that for the high degree of reliability required for the monitoring of a wire break, it would be better to rely on switch rather on a sensor. Wire break causes wire slack, yet there are cases that the wire become less tight to some degree while intact. For example due elevated temperature and humidity, or worn out. Thus, according to some embodiments when the wire tightness deduces, the biasing means releases its stored energy. The storing of energy by the biasing means occurs during the wire stretching. As was mentioned, in some embodiments, during the energy release the biasing means change its shape. For example, where the biasing means is a spring, it stretches during the stretching of the wire and shrinks during energy release. In some embodiments, the case can be the other way around. The spring is compressed, during wire stretching and expands during energy release. This compression and expansion of the spring is accompanied by a change it the spring's shape, e.g. its length. The position of the switch along the length of compression/stretch of the spring allows determining the amount of energy release that will cause the actuation of the switch. For more sensitive alarming, the switch would be located such that even a limited change in the spring shape will cause actuation. Yet, when it is desired to relax the sensitivity, the switch would be located to allow more stored energy release before it is actuated. The compromise on the sensitivity is intended to prevent false alarm and increase reliability.

According to some embodiments of the invention, a mechanical tensioning system is installed in each selected eruv post for stretching the eruv wire. A common wire being used today is a fishing line with a thickness of 1.6 mm with a typical distance between the posts is about 35 meters. In an example of such an eruv set-up, according to some embodiments, a spring tensioner is installed having a range of longitudinal movement of about 40 cm. The spring provides a conservative force of about 10 kg when the spring is compressed to stretch the eruv wire. The reader may understand that different types of wires may require adjustments to the tensioner movement length and spring force. This is because of the differences in flexibility in different kinds of wires. The spring's length in both its relaxed and energetic states is also influenced by its structural properties, including resistance and elasticity. Other relevant considerations within the scope of the present invention may include differences in eruv set-ups, e.g., different distances between the columns. An important purpose for the force applied by the spring is to keep the eruv thread stretched and in a halachically correct state. By this, the need to deal with and repair loose threads is reduced. In some examples, when the thread is torn, the spring would still apply some force. For instance, in the example with the fishing line mentioned above, the spring would still provide a residual force of 2.5 kg in order to still pull the torn thread, thus facilitating the verification, e.g., visually, that the thread is torn. The residual force of the spring can vary depending on the working conditions and the properties of the system components such as the wire and the spring. The residual force can be a certain proportion of the maximum force exerted by the spring such as 5%, 10%, 15%, 20%, 25%, and so on. According to some embodiments of the invention, erecting or repairing eruv is made from the ground using the same means used today including telescopic poles for elevating the threads on top of the eruv poles.

When the thread is torn, its tension is lost. In some embodiments, this activates an alarm. Yet, in some embodiments, the system can differentiate between loss of tension due to a tear, and reduction in tension that may occur due to other reasons, such as alteration of the thread's elasticity during time. The reduction in tension due to such reasons is typically smaller than when the thread is torn. Alarms caused by tension loss smaller than the tension loss caused by a tear may be considered false and should be avoided.

In some embodiments, the avoiding of false alarms is based on the correlation between the tensioner travel and the thread's tension. In some examples, a switch is placed at the point where the tensioner reaches when the thread is torn. When the tensioner reaches the switch, it activates it and causes an alarm. As long as the tensioner does not reach the switch, there is no alarm. Thus the tensioner is free to travel along some distance, reacting to changes in the thread's tension, while keeping the thread sufficiently tight without causing false alarms. An example of a spring-type tensioner may be helpful in understanding the above. There are examples embodying the invention where the spring while relaxing as a result of tension loss in the thread, elongates. Yet, there are examples where the spring shrinks during tension loss. Taking the example where the spring elongates, according to the above, the switch location is such that when the spring reaches its full, or almost full relaxation elongation, when the thread loses its tension due to a tear, e.g., 40 centimeters, the switch is being activated. This ensures that in case of a lesser elongation of the spring, the switch is not activated. In some embodiments, a plurality of switches is installed for redundancy in case one switch fails. In some examples, switches are installed at different positions to report or alarm on different degrees of thread tension loss. This can be useful, for example, in cases where tears are a result of the gradual deterioration of the thread's elastic properties. In this manner, preventive maintenance can be applied. The positions of the switches are determined also by the spring's properties. The spring's lengthening is influenced by its structural properties, including resistance and elasticity.

Pole tilt can cause excess tension in the thread. In some cases, this may prevent detecting loss of tension in the thread. As explained earlier, in some embodiments a tilt sensor is installed for detection of pole inclination. According to some embodiments, the processor offsets the effect of the column inclination in the wire tension calculation. In this way, it is possible to independently and more accurately monitor two possible faults-column tilt and wire slack.

According to some embodiments of the invention, the signals generated by the tilt sensor and by the actuation of the switch, are transmitted to a control center. The eruv poles may be networked in a manner that transmissions are forwarded from one pole to the next. Each pole may be identified by the control center, possibly by the display module, for example utilizing item codes. In some embodiments, the system identifies poles where alarm signals are generated and poles where alarms are not generated, which may be referred to as ‘silent poles’ or ‘proper poles.’ Signal transmission occurs from one pole to another in a common path without mutual interference between the signals generated at each pole. The transmission may be directed to the control center either wiredly or wirelessly. In some cases, a main transmitter is communicatively connected in parallel to multiple poles for receiving signals if generated independently at each pole. Alternatively, the main transmitter receives transmissions of signals passing from one pole to another, as explained above. The main transmitter forwards signals generated at multiple poles and transmits them together to the control center, possibly to the display module. Another topology for the communication between the switches and sensors and the control center is a mesh network. Mesh network topologies create multiple routes for information to travel among connected nodes. This may increase the resilience of the network in case of a node or connection failure. In a full mesh network topology, each node, e.g. switch or sensor is connected directly to all the other nodes. In a partial mesh topology, only some nodes connect directly to one another. In some cases, a node must go through another node to reach a third node, a topology that more resembles what was described above. According to some embodiments of the invention, SIM communication is implemented between the control center and other components such as sensors and switches, as well as to communicate information to users and consumers that may be interested in the integrity of the eruv. These could be cell phone users from the observant Jewish community, management personnel in the local rabbinate and system operators. In some embodiments, the repair team may receive a map or directions to a computerized device such as a cellular phone. This can be done in conjunction with a navigation applet, such as Google Maps.

According to some embodiments of the invention, the installation of the eruv is done by installing a tensioner on the side of the pillar. The tensioner is installed on the pillar and then the alarm system is installed. It is not necessary that the tensioner and the alarm system including the switch be installed on each eruv pillar. It is possible, for example, that they will be installed on one of every two adjacent pillars.

According to some embodiments of the invention, the method of installing and replacing an eruv wire is done using a long telescopic rod to mount the new eruv wire on the top of the first pillar while continuing to raise the wire to the next pillar with the telescopic rod. The wire is moved to the designated place on the top of the pillar, sometimes called a guide, and the wire is then lowered from the top of the pillar through a pulley. The wire is then put on the tensioner pulley and lowered down. The tensioner arm will at this point go down and compress the tension spring. At this stage, the wire is stretched down until the tensioner reaches its maximal possible displacement. and fasten it to the post. After that, the thread is tied as is customary today, for example to a anchoring point installed on the side of the pillar.

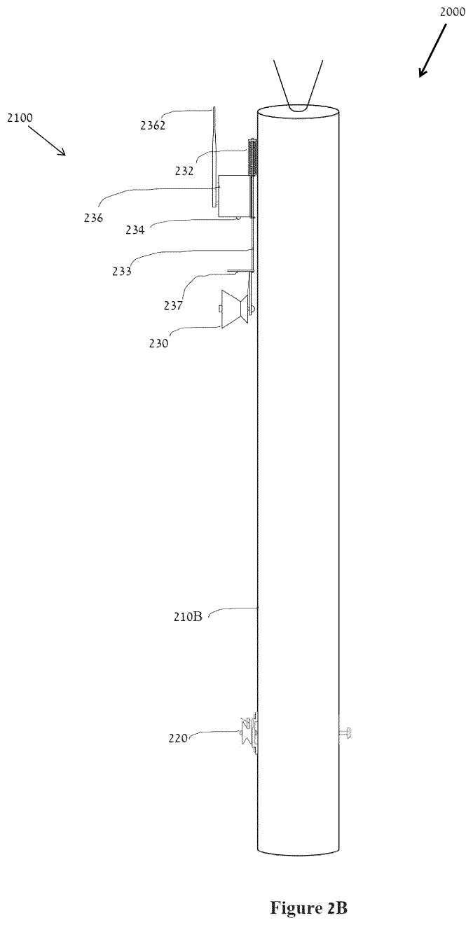

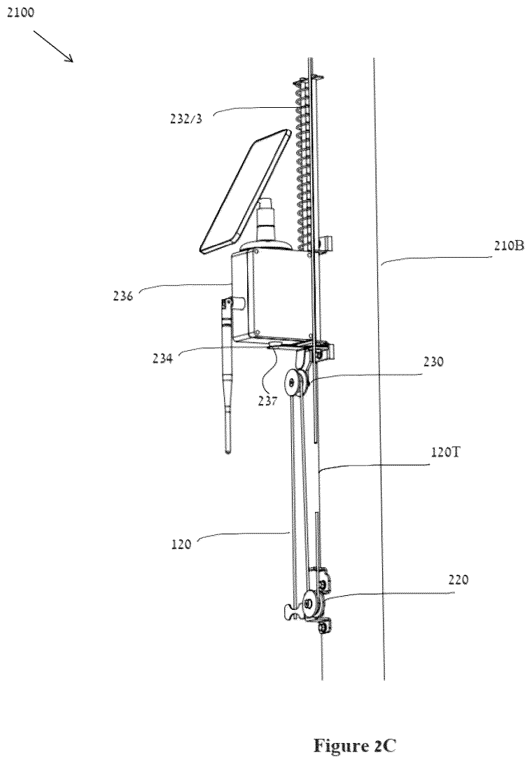

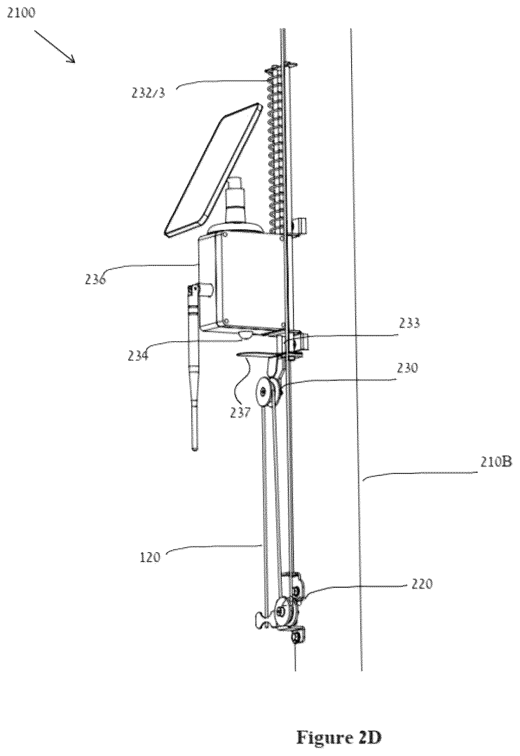

We will now move on to a description accompanied by figures illustrating some embodiments of the invention. FIGS. 2A and 2B illustrate eruv pole assembly 2100 of system 2000 according to some embodiments of the invention with eruv wire 120 properly taut as seen from different perspectives denoted as ‘A’ and ‘B,’ respectively. Assembly 2100 includes pole 210B with wire guide 214B installed on its top. Wire 120 coming from another eruv pole, descends from guide 214B towards pulley 220. Wire 120 is threaded through pulley 220 and ascends towards pulley 230, threaded there too. From pulley 230, wire 120 descends and stretched towards anchoring point 224, where it is fastened and secured. Anchoring point 222 seen opposite anchoring point 224 is used as an aid during wire 120 arrangement and is not used when wire 120 is in its final position. Pulley 230 is connected to the upper ends of springs 232 by means of rods 233. When wire 120 is stretched, pulley 230 is lowered by the force exerted on it due to the tension of wire 120 against the resistance of springs 232. The force applied when stretching wire 120 causes in the present example to contract springs 232 relative to their relaxed state. Since rods 233 are connected in their lower part to pulley 230, their movement causes springs 232 to contract. Unlike rods 233, which are allowed to move down together with pulley 230, the lower part of springs 232 is fixed in place. The movement of the upper part of springs 232 together with rods 233 occurs while the lower part of springs 232 cannot move and therefore springs 232 are contracted. The situation shown in FIGS. 2A-B is when wire 120 is stretched, and springs 232 are compressed. Also shown is the alert module of eruv pole assembly 200. The alert module includes, in the present example, case 236 designed to resist different external conditions such as radiation, humidity, and heat. Inside case 236, there are components including a transmitter and a tilt sensor, (both are not shown), except for transmission antenna 2362, which is visible in FIG. 2B. Additionally, the alert module features switch 234 and actuator 237, which moves in conjunction with pulley 230. Case 236 contain a battery. In some examples the transmitter may be modem and/or GSM-based, allowing it to identify the specific pole in the control center to which the alert signals are sent. Now, FIGS. 2C-D show assembly 2100 in different situations from FIGS. 2A-B. FIG. 2C shows tear in the wire 120T. Now, there is no tension in the wire 120 and there is no force pulling pulley 230 down. As a result, springs 232, one of which appears in FIG. 2C, return to their relaxed, uncompressed state. Actuator 237 moving up together with pulley 230 and rods 233 meets switch 234 and presses it. Switch 234 is coupled to a transmitter that sends an alert to the control center for example. It can be seen that rods 233 whose in FIGS. 2A-B were seen at least partially under and outside springs 232, now tucked into springs 232 because they are attached to the top of the springs 232 and there is no force now pulling them out of the springs 232 as when wire 120 taut. Another situation is depicted in a FIG. 2D. There is no tear 120T now but it is shown that pulley 230 did rose, yet less compared to its rise in FIG. 2C. This situation can occur, for example, due to a change in the elastic properties of wire 120. Actuator 237 does not meet switch 234 and an alert is not transmitted to the control center. Also, springs 232 still exert an opposing force to the force pulling pulley 230 down thereby keeping wire 120 taut.

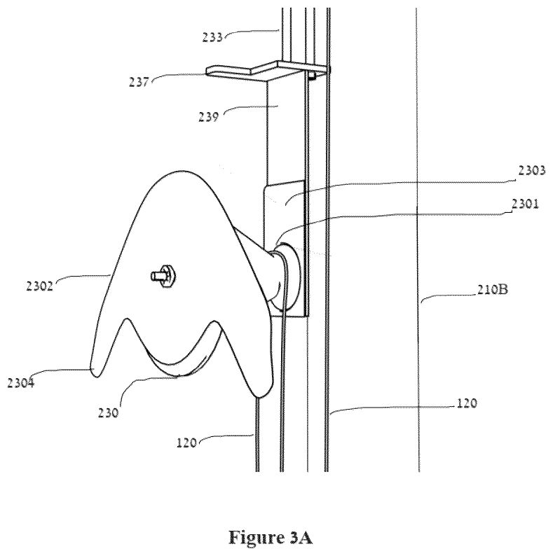

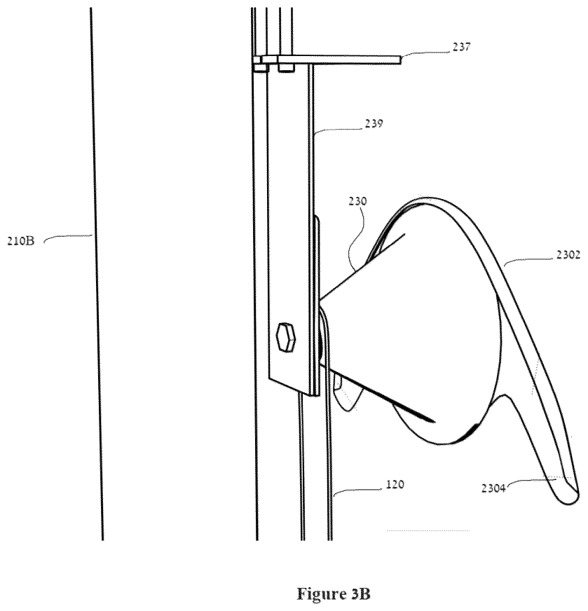

We will now move on to more focused descriptions of parts of assembly 2100 according to some embodiments. FIGS. 3A-B focus on the surroundings of pulley 230. Bracket 239 is connected to actuator 237 and pulley 230, allowing pulley 230 and actuator 237 to move together vertically. The conical structure shown of pulley 230 is intended to assist in the installation of wire 120 from the ground using a telescopic rod (not shown), by assisting to direct wire 120 closer to pole 210B. Further, on the side of pulley 230 remote from the column 210B is installed cover 2302 with two co-planar extensions 2304. The purpose of cover 2302 is to assist in threading wire 120 through pulley 230 from the ground. Cover 2302 does not rotate with pulley 230. In some examples, cover 2302 is suspended on the shaft of pulley 230 but is not fastened to it. Instead, the shaft acts as an anchor point for cover 2302 without transferring rotational movement. The shaft passes through a hole in cover 2302 wide enough to minimize friction. To prevent the cover 2302 from slipping off the end of the shaft, the shaft expands at its end to a larger diameter than the hole in cover 2302. Alternatively, rotation of cover 2302 may be prevented by a bearing located between the shaft and the hole rims in cover 2302 through which the shaft passes. In some examples illustrated in FIGS. 3A-B, extensions 2304 point downward at an angle less than 90 degrees relative to the plumb line. In some examples, as illustrated in FIG. 3B, the thickness of the extensions 2304 decreases from the side of cover 2302 that is remote from pulley 230 toward their ends. Additionally, the edges of cover 2302 facing upward are bent in a rounded manner towards pulley 230. This design reduces potential friction between wire 120 and cover 2302 when threading wire 120 through pulley 230.

Another way to facilitate the threading of wire 120 through pulley 230 is by its large size compared for example to pulley 220 which is located lower in hands reach and does not necessitate using tools like telescopic rod. For example, conical pulley 230 shown in FIGS. 3A-B may have the rim remote from pole 210B, of a diameter ranging from 6 to 10 centimeters. The rim closer to pole 210B may have a diameter ranging from 2 to 6 centimeters. In some examples, the total width of pulley 230 ranges from 6 to 8 centimeters, while the inside width between the rims can be 3 to 5 centimeters. According to some examples, the length of the extensions 2304 can be in the range of 4 to 8 centimeters, and their ends will reach 2 to 4 centimeters below the bottom edge of the cover 2302.

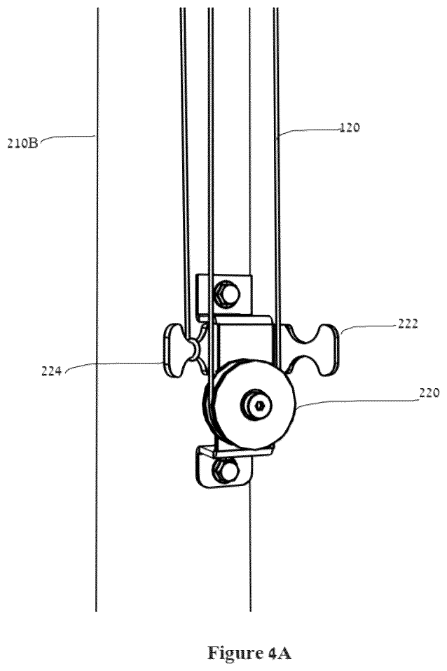

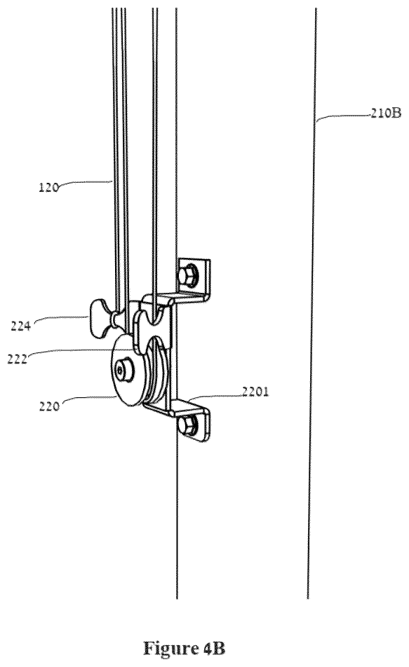

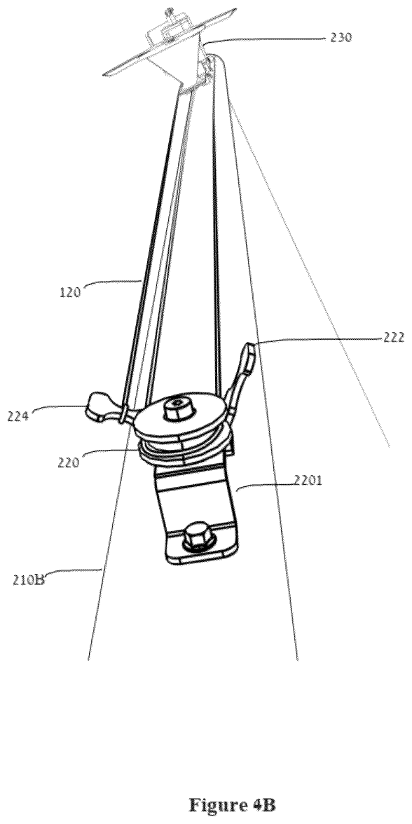

We will now shift our focus to the area around pulley 220. FIGS. 4A-C provide three different perspectives of this section. Wire 120 is depicted threaded through pulley 220 and secured to anchoring point 224. FIGS. 4B and 4C show bracket 2201 on which pulley 220 and anchor points 222 and 224 are mounted. Wire 120 is secured to anchor point 224 permanently after the eruv is erected, but may be disconnected during erection and repair. Anchor points 222 purpose it to assist during erection and repair. Anchor point 222 is used to temporarily secure wire 120 when it is raised to guide 214B or lowered from guide 214B toward pulley 220. The disconnection of wire 120 from anchoring point 222 can be done after wire 120 has been threaded through guide 214B or after threading wire 120 in pulley 230, respectively.

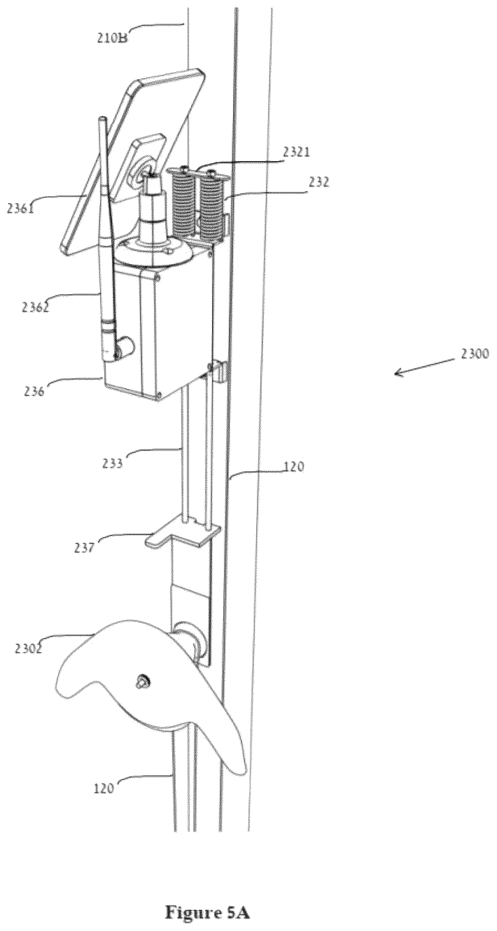

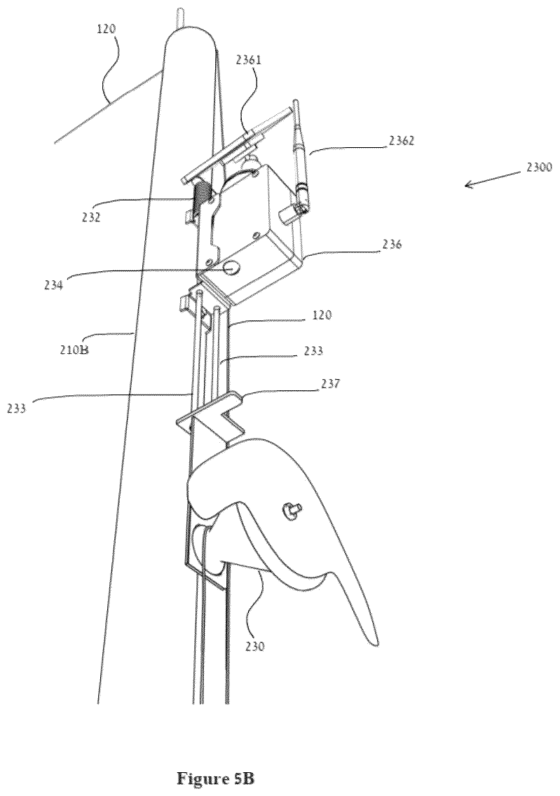

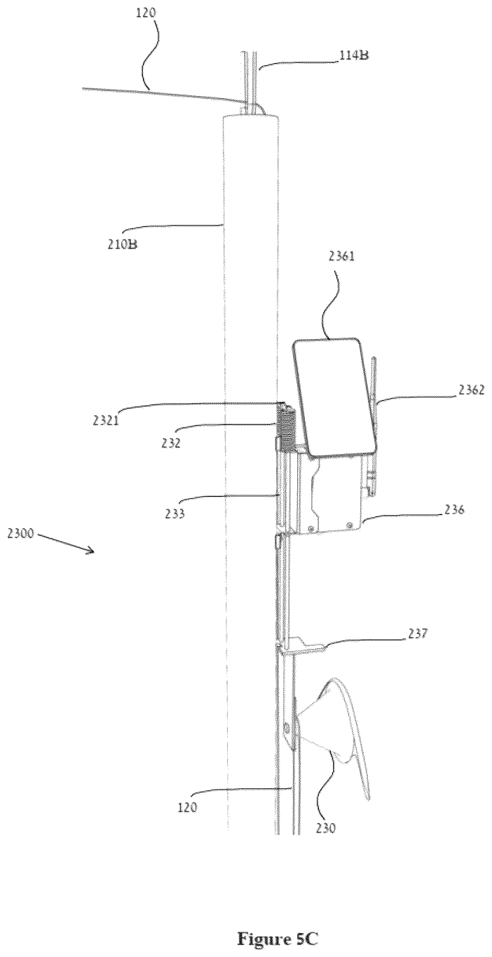

FIGS. 5A-C illustrate the vicinity of alert module 2300 from three perspectives. Case 236 can be seen fixed to pole 210B and a photovoltaic surface 2361 for storing radiation energy, fixed on case 236. Springs 232 are seen in their contracted state, and rods 233 are seen partially protruding from springs 232. The protruding part of rods 233 which is outside of springs 232 is partially hidden in FIGS. 5A-B behind case 236. It can be seen that the rods 233, in the part outside the springs 232 pass through openings in the bracket connecting case 236 to the pole 210B. This is different from springs 232, which their lower ends are blocked by said bracket. Member 2321 connecting the top end of rods 233 to the top end of springs 232. More parts discussed earlier are shown such as actuator 237, switch 234, pulley 230, and cover 2302.

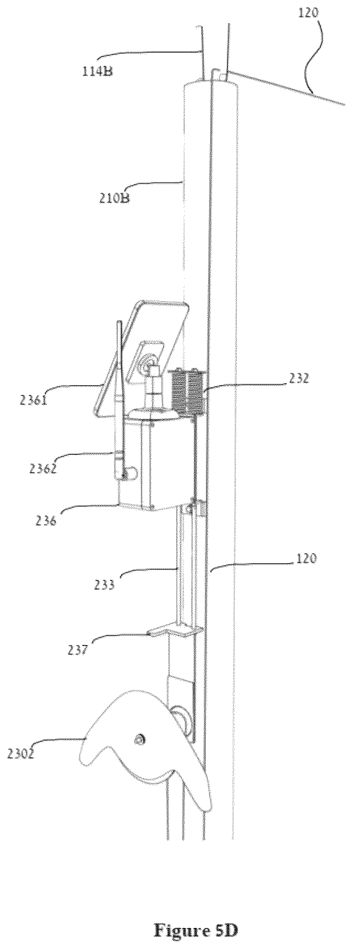

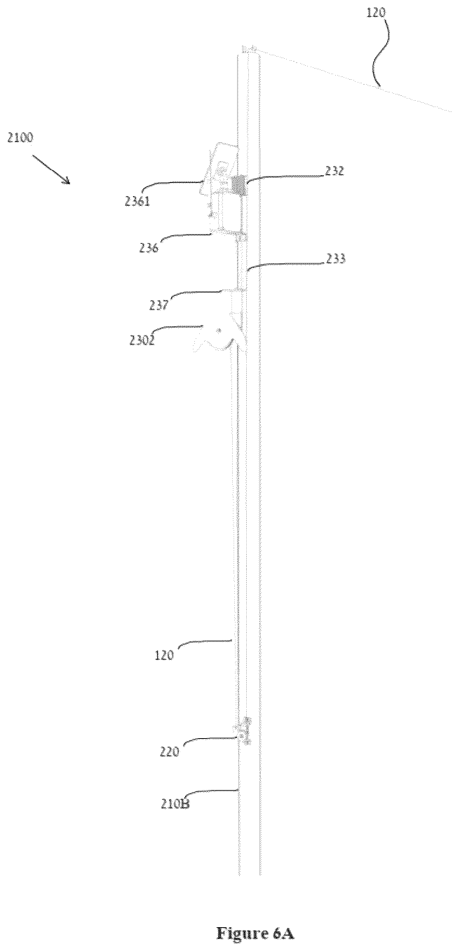

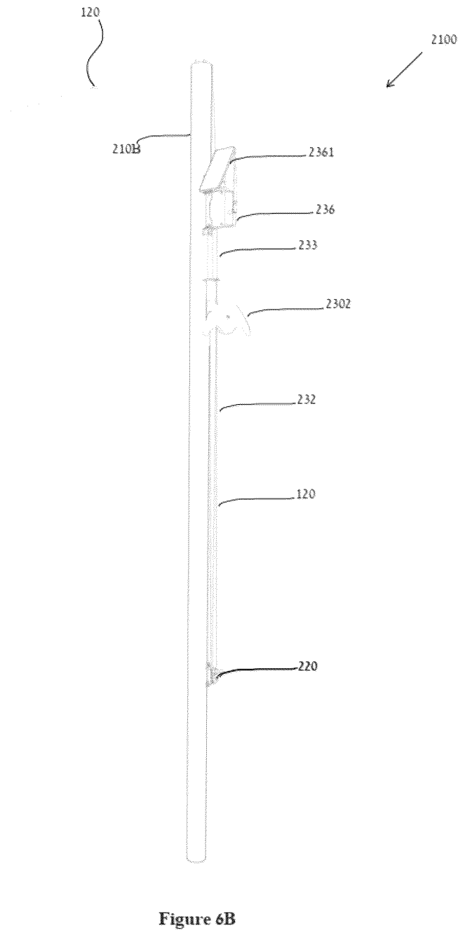

FIGS. 6A-B are two perspectives of the entire 2100 assembly, which includes the features described in the previous figures.

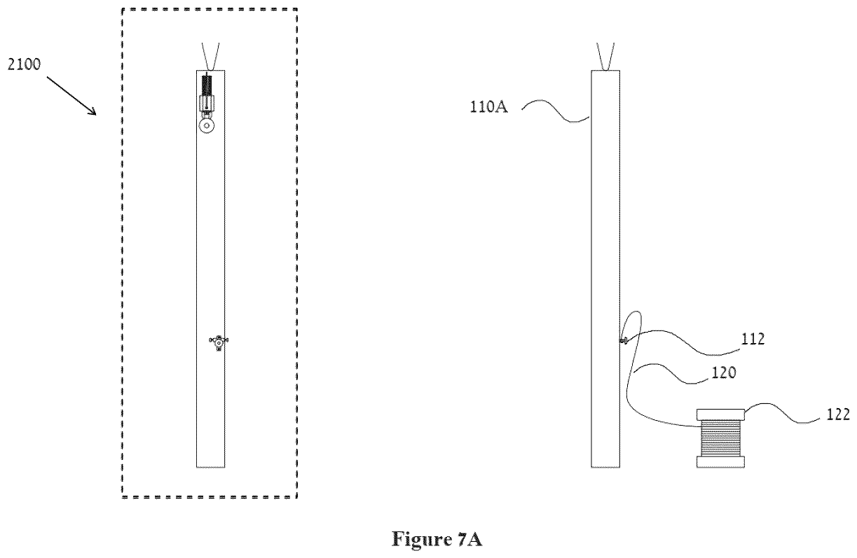

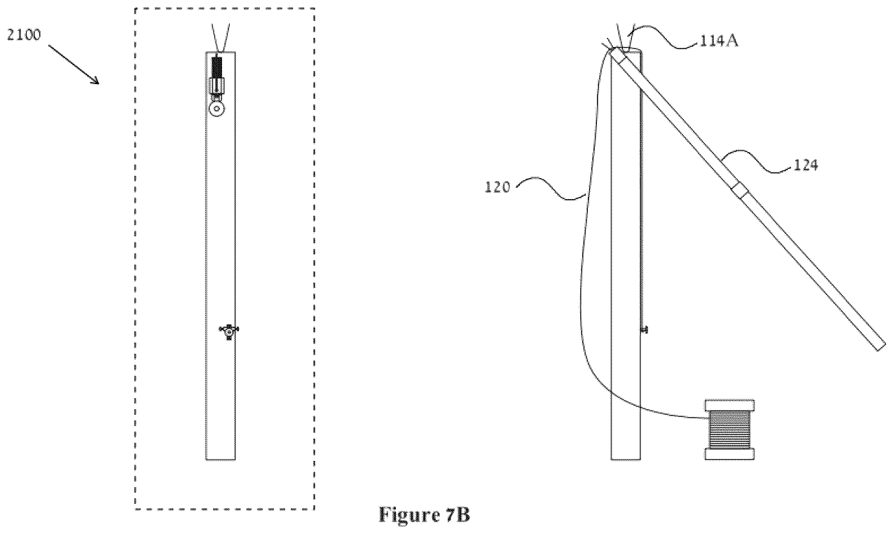

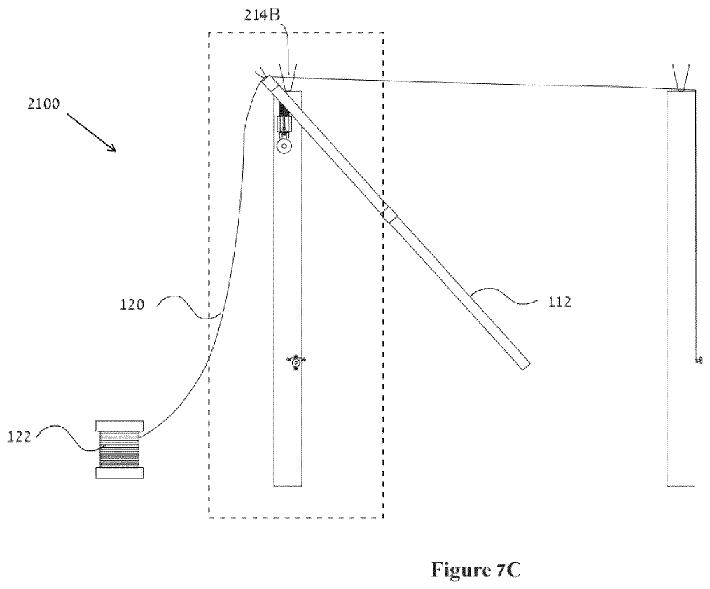

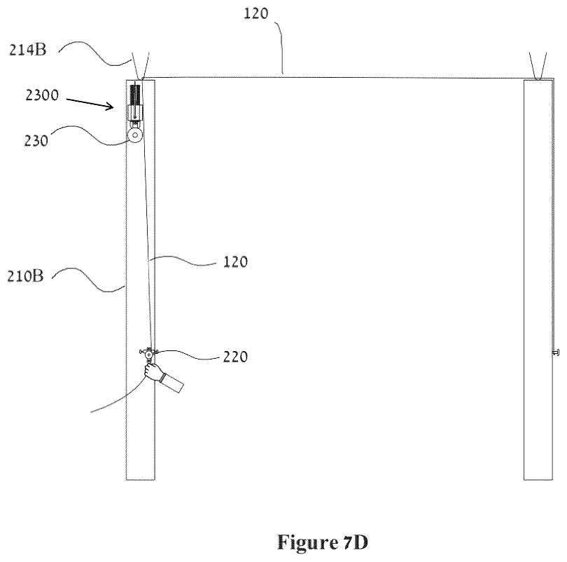

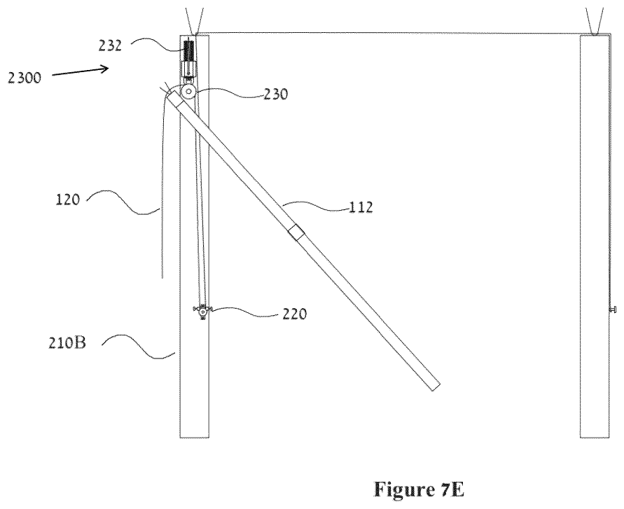

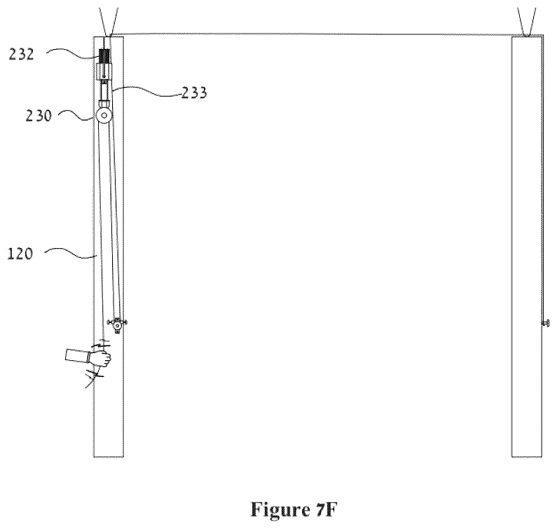

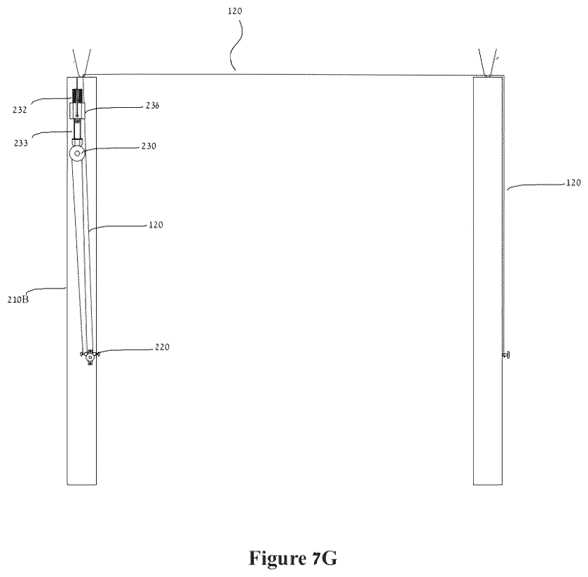

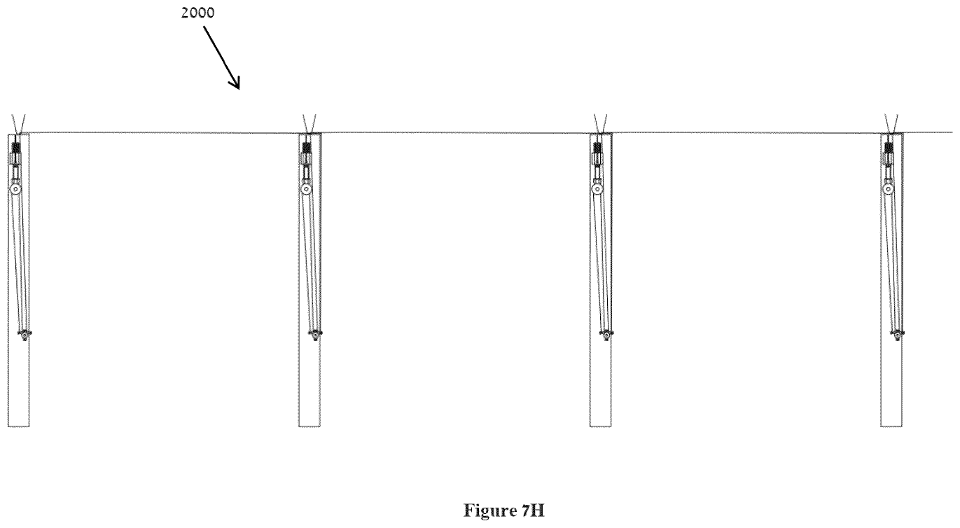

One of the possible ways of erecting an eruv is depicted in FIGS. 7A-G. In the present example we have chosen to illustrate the erection of a section of eruv according to embodiments of the invention in continuation to a prior art. That is, the eruv section embodying the invention starts where the prior art eruv ends so that the now the eruv combines a prior art section and a section exemplifying the invention. The figures here do not include an illustration of the installation of columns 210B which is done similarly to the prior art. Also, the figures do not illustrate the assembly of the smart eruv pole assembly 2100 whose structure has been described in detail in the previous figures. FIGS. 7A-E focus on eruv wire installation. The first stage of erecting the eruv is schematically depicted in FIG. 7A where bundle 122 of new eruv wire 120 appears positioned near first prior art eruv pole 110A situated next to assembly 2100. The free end of eruv wire 120 is attached to an anchoring point 112 on pole 110A, which can be, for example, a lug, eyelet, nail, screw, or similar fastener. The next step is depicted in FIG. 7B where telescopic rod 124 is used to raise wire 120 to guide 114A installed at the top of pole 110A. Next, as shown in FIG. 7C, using telescopic rod 112, wire 120 continuation is guided up to guide 214B installed on top of pole 210B. After that, bundle 122 is moved near assembly 2100. Next, as depicted in FIG. 7D wire 120 is pulled downwards from guide 214B. Then, as illustrated in FIG. 7E wire 120 is threaded through pulley 220, and is elevated and threaded through pulley 230 by using rod 112. As discussed above, before or after threading wire 120 through pulley 220 it may be helpful to temporarily secure wire 120 to an anchor point 222. The next step is depicted in FIG. 7F which illustrates how wire 120 is pulled down while stretching. As also discussed in previous paragraphs, the force applied to stretch thread 120 causes downward movement of pulley 230 together with rods 233. Since rods 233 are connected to the upper end of springs 232, and since the lower part of these springs is fixed in place, springs 232 contract due to the downward movement of rods 233. Finally as depicted in FIG. 7G wire 120 is stretched and secured to an anchor point 224. FIG. 7H illustrates several eruv poles in sequence with wire 120 installed according to some embodiments of the present invention.

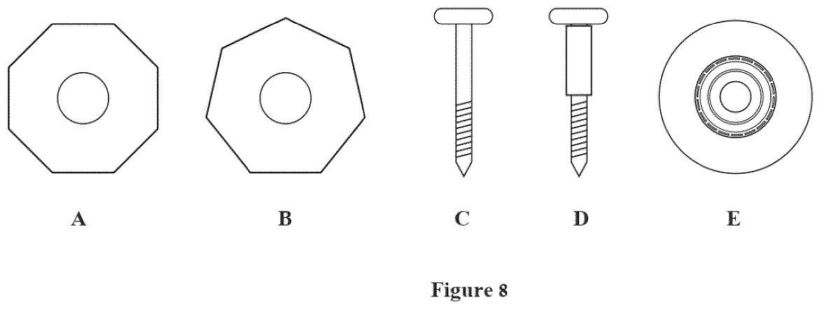

Possible substitutes for the pulleys described above, although not necessarily as effective, are illustrated in FIG. 8: polygonal pulleys A and B, nail C, nail threaded in the tube D, bearing E. Bearing E can take on various forms/types, including ball, roller, conical, and radial.

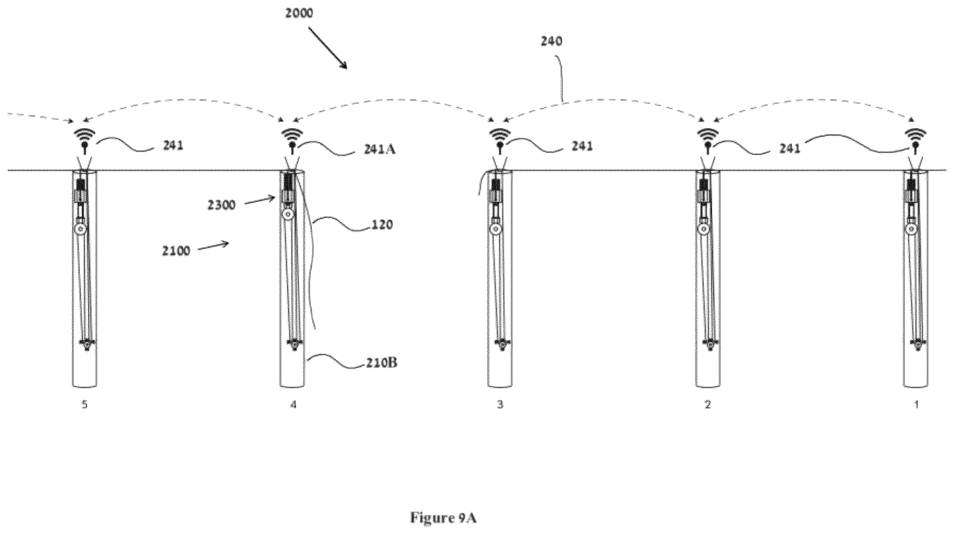

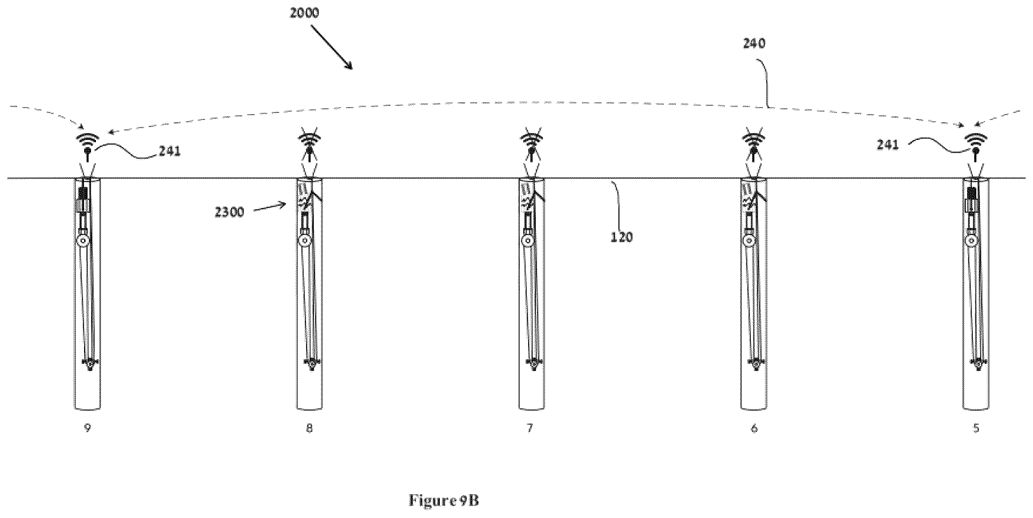

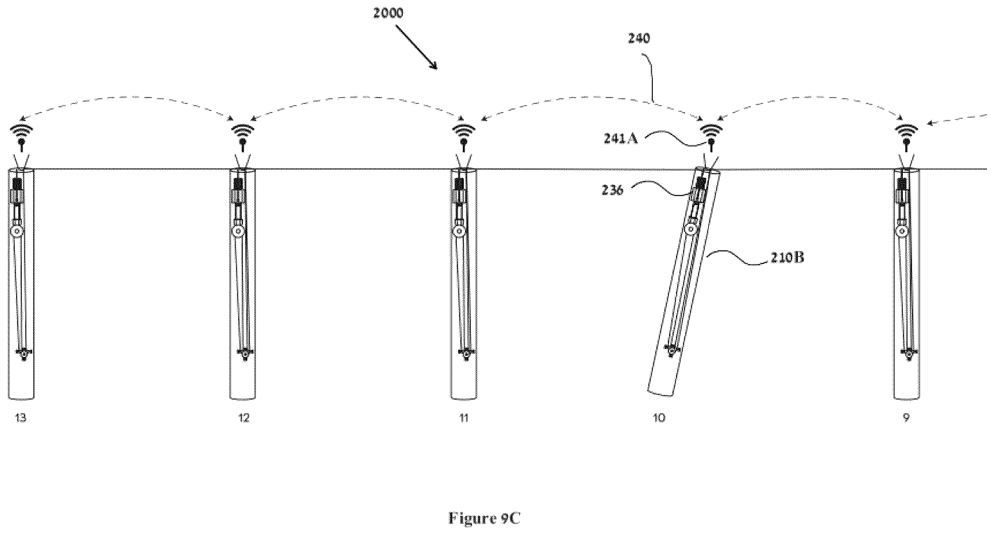

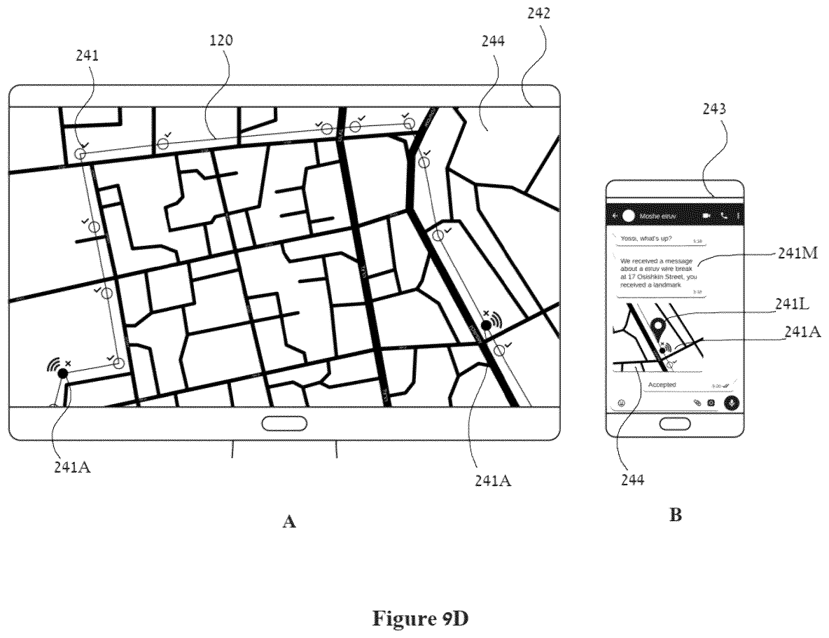

System 2000 for monitoring and controlling eruv, and locating and specifying eruv malfunctions embodying the invention is depicted in FIGS. 9A-D. The figures illustrate system 2000 that includes a computerized control means that receives alert signals from modules 2300 surrounding eruv zone. While FIGS. 9A-C illustrate various types of faults and alert transmissions, FIG. 9D illustrates possible modes of displaying eruv status, including fault alerts. In the present example, module 2300 transmits, in addition to alert and location signals, a “heartbeat signal” 241 indicating module 2300 active and operational. FIG. 9A illustrates network communication 240 in which signals are transmitted from modules 2300 at locations 1-5 where smart eruv pole assemblies 2100 are installed. It is illustrated that alert module 2300 in location 4 transmits an alert signal 241A about a rupture in wire 120. The other modules 2300 only transmit a “heartbeat signal” 241. The locations can be stored in system memory or cloud, alternatively the locations are transmitted from modules 2300. Locations may be determined, for example, using GPS, Cellular and Network-Based Location Services, Bluetooth and Beacon Technology, IP Address Geolocation. A combination of these methods may be used to ensure accurate and reliable location information, especially in complex urban environments. FIG. 9B schematically illustrates that at locations 6-8 no “heartbeat signal” 241 is received. FIG. 9C schematically illustrates that at position 10 an alert signal 241A is received due to a tilted pole. FIG. 9D schematically illustrates an online map display of the state of the eruv on a computer screen and a mobile phone screen according to some embodiments of the invention. On computer screen A, display 242 shows signals being received from modules 2300 for each smart eruv pole assembly 2100 that its location is shown on a map of urban area 244. Also shown is the route of wire 120 passing through each of the assemblies 2100. Display 242 shows “heartbeat” signals 241 from eleven assemblies 2100, and two alert signals 241A for two assemblies 2100 at two different locations. Mobile phone screen B shows display 243 of part of what was displayed on display 242. Also shown is a landmark icon 241L corresponding to the location from where one of the alert signals 241A was transmitted. Also appearing in display 243 automatically generated message 241M specifying the address corresponding to icon 241L. For the clarity of the display, each indicator, including 241, 241A, and 241L mentioned above, is represented by a unique icon, often following accepted conventions. In some examples, a combination of common applications of instant messages and navigation, for example, to dispatch maintenance teams to the locations from which alert signals were transmitted.

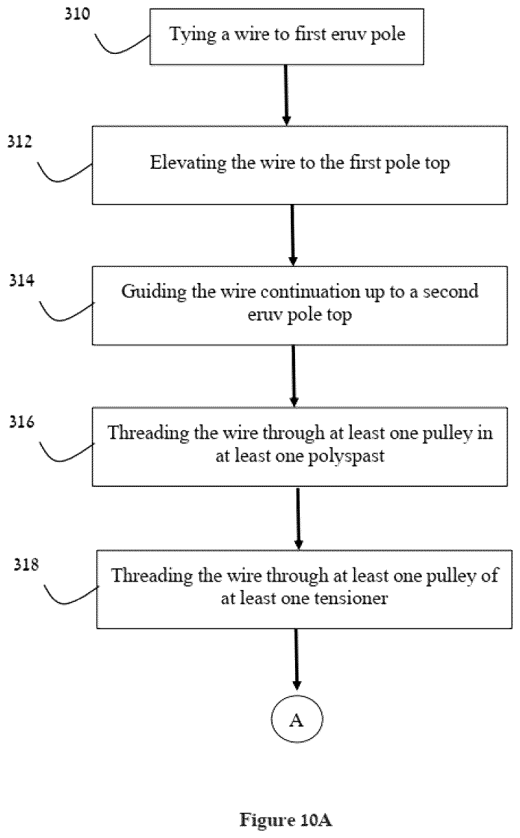

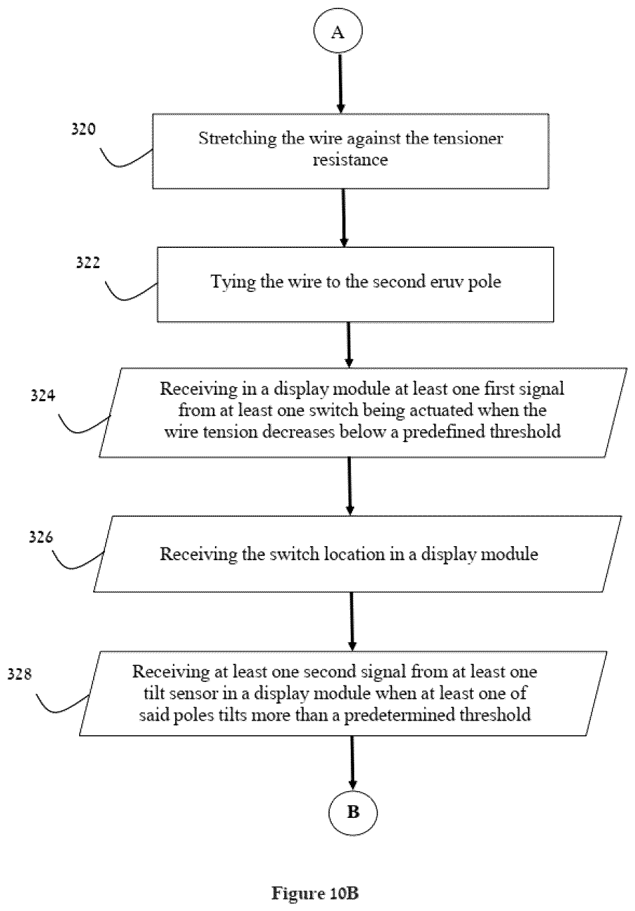

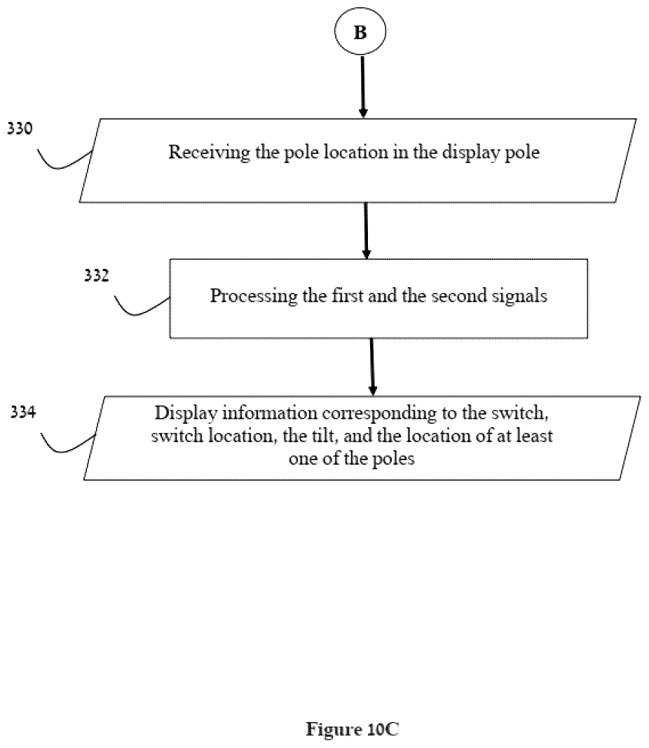

A method according to some aspects of the invention is depicted in FIGS. 10A-C. The method includes tying a wire to first eruv pole 310; elevating the wire to the first pole top 312; guiding the wire continuation up to a second eruv pole top 314; threading the wire through at least one pulley in at least one polyspast 316; threading the wire through at least one pulley of at least one tensioner 318; stretching the wire against the tensioner resistance 320; tying the wire to the second eruv pole 322; receiving at least one first signal from at least one switch being actuated when the wire tension decreases below a predefined threshold 324; receiving the switch location 326; receiving at least one second signal from at least one tilt sensor when at least one of the poles tilts more than a predetermined threshold 328; receiving the pole location 330; processing the first and second signals 332; and display information corresponding to the switch, the switch location, the tilt, and the location of at least one of the poles 334.

It should be understood that elements and/or features of an apparatus, or a method described herein can be combined in a variety of ways without departing from the spirit and scope of the present teachings, whether explicit or implicit herein. For example, where reference is made to a particular structure, that structure can be used in various embodiments of apparatus of the present teachings and/or in methods of the present teachings, unless otherwise understood from the context. In other words, within this application, embodiments have been described and depicted in a way that enables a clear and concise application to be written and drawn, but it is intended and will be appreciated that embodiments may be variously combined or separated without parting from the present teachings and invention(s). For example, it will be appreciated that all features described and depicted herein can be applicable to all aspects of the invention(s) described and depicted herein.

It should be understood that the expression “at least one of” includes individually each of the recited objects after the expression and the various combinations of two or more of the recited objects unless otherwise understood from the context and use.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

The use of the singular herein, for example, “a,” “an,” and “the,” includes the plural (and vice versa) unless specifically stated otherwise.

The use of any and all examples, or exemplary language herein, for example, “such as,” “including,” or “for example,” is intended merely to better illustrate the present teachings and does not pose a limitation on the scope of the invention unless claimed. No language in the specification should be construed as indicating any non-claimed element as essential to the practice of the present teachings.

The present teachings encompass embodiments in other specific forms without departing from the spirit or essential characteristics thereof. The foregoing embodiments are therefore to be considered in all respects illustrative rather than limiting on the present teachings described herein.

Further, one skilled in the art will recognize that functional units in this description have been labeled as modules throughout the specification. The person skilled in the art will also recognize that a module may be implemented as processor, circuits, logic chips or any sort of discrete component. Still further, one skilled in the art will also recognize that a module may be implemented in software which may then be executed by a variety of processor architectures. In embodiments of the invention, a module may also comprise computer instructions or executable code that may instruct a computer processor to carry out a sequence of events based on instructions received. The choice of the implementation of the modules is left as a design choice to a person skilled in the art and does not limit the scope of this invention in any way.

1. An eruv pole configured for maintaining and controlling eruv in accordance with the requirements of Halacha comprising:
at least one wire;
at least one biasing means storing energy during stretching of said wire;
at least one switch being actuated during a release of said stored energy;
at least one transmitter communicably coupled to said switch, said transmitter sending at least one signal according to said switch status, said signal indicative of said wire tension; and
at least one polyspast with at least one moving pulley translated by said biasing means, said moving pulley and said biasing means cooperate together as a tensioner for maintaining tension in said wire as long as said wire remains intact.

2. The pole of claim 1 comprising at least one tilt sensor that sends at least one signal when said pole tilts more than a predetermined threshold.

3. The pole of claim 1 wherein said biasing means selected from the group consisting of a spring, an elastic band, a torsion bar, a pneumatic cylinder, a hydraulic cylinder, a magnet and combinations thereof.

4. The pole of claim 1 wherein said actuation occurs when said energy release is greater than a predetermined threshold.

5. The pole of claim 1 wherein said energy release causes said biasing means to change shape.

6. The pole of claim 5 wherein said change in shape causes said actuation of said switch.

7. The pole of claim 5 wherein said moving pulley is connected to said biasing means such that said change in shape causes said translation.

8. A system for monitoring and controlling eruv, and locating and specifying eruv malfunctions, said system comprising:
at least one wire;
at least two eruv poles connected with said wire;
at least one biasing means storing energy during stretching of said wire;
at least one switch being actuated during a release of said stored energy;
at least one polyspast with at least one moving pulley translated by said biasing means, said moving pulley and said biasing means cooperate together as a tensioner for maintaining tension in said wire as long as said wire remains intact; and
at least one transmitter communicably coupled to said switch, said transmitter sending at least one first signal according to said switch status and said switch location.

9. The system of claim 8 comprising at least one tilt sensor that sends at least one second signal regarding said pole tilt and location.

10. The system of claim 8 wherein said actuation occurs when said energy release is greater than a predetermined threshold.

11. The system of claim 8 comprising at least one display module, said display module configured to receive and process said first signal, and to display information corresponding to said switch, and said switch location.

12. The system of claim 9 comprising at least one display module, said display module configured to receive and process said second signal, and to display information corresponding to said tilt, and said pole location.

13. A method for monitoring and controlling eruv compliance with Halacha requirements comprising:
tying a wire to a first eruv pole;
elevating said wire to said first pole top;
guiding said wire continuation up to a second eruv pole top;
threading said wire through at least one pulley in at least one polyspast;
threading said wire through at least one pulley of at least one tensioner;
stretching said wire against said tensioner resistance;
tying said wire to said second eruv pole;
receiving at least one first signal from at least one switch being actuated when said wire tension decreases below a predefined threshold; and
receiving said switch location.

14. The method of claim 13 comprising receiving at least one second signal from at least one tilt sensor when at least one of said poles tilts more than a predetermined threshold; and receiving said pole location.

15. The method of claim 14 comprising processing said first and second signals to display information corresponding to said switch, said switch location, said tilt, and said location of at least one of said poles.
